(19) United States
(12) Patent Application Publication
(10) Pub. No.: US 2024/0152974 A1
(43) Pub. Date: May 9, 2024

(54) CLOUD-BASED AUTOMATED CONTENT CREATION SYSTEM

(71) Applicant: CapSure Marketing, LLC, Celina, TX (US)

(72) Inventors: David Einhorn MOON, Cellna, TX (US); Bryce Richard Perry, Marietta, GA (US); Michael Duco Abraham, Georgetown, TX (US); Gabrielle Lynn Valderas, Plano, TX (US)

(73) Assignee: CapSure Marketing, LLC, Celina, TX (US)

(21) Appl. No.: 18/388,025

(22) Filed: Nov. 8, 2023

Related U.S. Application Data
(60) Provisional application No. 63/423,886, filed on Nov. 9, 2022.

(51) Int. Cl. G06Q 30/0241; G06Q 50/00

(52) U.S. Cl. CPC G06Q 30/0276; G06Q 50/01

(57) ABSTRACT

A cloud-based computer implemented method for automatic generation and publication of custom content includes: receiving, by an orchestrator, a first task to be performed from a schedule database; instructing, by the orchestrator, an engine to perform the first task; receiving, by the engine, data comprising profile data, a template from a content library, and content data; and rendering, by the engine, the custom content by creating a plurality of layers, each layer of the plurality of layers comprising an aspect of one or more of the data, and combing the plurality of layers to create the custom content.

### CROSS-REFERENCE TO RELATED APPLICATIONS

This patent application claims priority from, and incorporates by reference the entire disclosure of U.S. Provisional Patent Application No. 63/423,886 filed on Nov. 9, 2022.

### TECHNICAL FIELD

The present disclosure relates generally to generation of content and more particularly, but not by way of limitation, to a system and method of cloud-based automated content creation.

### BACKGROUND

This section provides background information to facilitate a better understanding of the various aspects of the disclosure. It should be understood that the statements in this section of this document are to be read in this light, and not as admissions of prior art.

Marketing is an essential part of customer-focused businesses. Digital marketing has grown quite a bit in recent years and is often the preferred method of marketing compared to more traditional marketing outlets such as printed publications, television, radio, etc. Digital marketing offers many benefits to businesses, including the ability to target specific customers (e.g., customers in a particular location, with known interests, etc.), to track activity relating to the marketing material (e.g., clicks, views, etc.), and to more quickly create and publish the marketing material compared to traditional marketing.

Despite these certain advantages, digital marketing also presents certain challenges. For example, the number of different digital marketing outlets (e.g., industry related websites and social media platforms) means that publishing digital marketing content to the various outlets can be time consuming and present certain technical challenges, especially for less experienced users. Additionally, the data and content needed for the creation of the digital marketing content is often scattered across a variety of different sources. The time needed to gather the necessary materials and generate the digital marketing content is compounded when the individual doing the marketing has many products/services to market. For example, in the real estate space, a user may have multiple properties to market and multiple digital marketing outlets to which content is published. Technical complications arise from the different requirements and methodologies used by different digital marketing outlets. Thus, a user may be prevented from simply submitting the same marketing material two different digital marketing outlets.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, a cloud-based computer implemented method for automatic generation and publication of custom content includes: receiving, by an orchestrator, a first task to be performed from a schedule database; instructing, by the orchestrator, an engine to perform the first task; receiving, by the engine, data comprising profile data, a template from a content library, and content data; and rendering, by the engine, the custom content by creating a plurality of layers, each layer of the plurality of layers comprising an aspect of one or more of the data, and combing the plurality of layers to create the custom content.

In some aspects, the method includes: writing, by the engine, the custom content to a content posts storage; and updating a content post metadata database.

In some aspects, the method includes instructing, by the orchestrator, a social media manager to publish the custom content to an external platform.

In some aspects, the method includes: polling by the orchestrator, a content post metadata database; and responsive to the custom content being found in the content post metadata databases, instructing, by the orchestrator, a social media manager to publish the custom content to an external platform.

In some aspects, the custom content is published as soon as it is available. In some aspects, the custom content is published at a scheduled time in the future.

In some aspects, the custom content is published to a social media platform designated in the profile data.

In some aspects, a first layer of the plurality of layers comprises a frame, the frame comprising a design element stored in the profile data. In some aspects, a second layer of the plurality of layers comprises data from the content data.

In some aspects, the first task is a record comprising parameters of the custom content including one or more of a user for which the custom content will be posted, a social media account where the custom content will be posted, a time by which the custom content will be posted, a content template for the custom content, and an identification of data sources for the custom content.

In some aspects, the first task is received from a user by a server in communication with the engine.

In some aspects, responsive to the first task being received by the server, the server pushes the first task to the schedule database.

In some aspects, the template is generated by artificial intelligence (AI). In some aspects, the template comprises one or more of an AI generated image and an AI generated text.

In some aspects, a non-transitory storage medium having stored thereon logic that, upon execution, causes operations including: receiving, by an orchestrator, a first task to be performed from a schedule database; instructing, by the orchestrator, an engine to perform the first task; receiving, by the engine, data comprising profile data, a template from a content library, and content data; and rendering, by the engine, the custom content by creating a plurality of layers, each layer of the plurality of layers comprising an aspect of one or more of the data, and combing the plurality of layers to create the custom content.

In some aspects, the operations further include: writing, by the engine, the custom content to a content posts storage; and updating a content post metadata database.

In some aspects, the operations further include: polling by the orchestrator, a content post metadata database; and responsive to the custom content being found in the content post metadata databases, instructing, by the orchestrator, a social media manager to publish the custom content to an external platform.

In some aspects, the first task is a record comprising parameters of the custom content including one or more of a user for which the custom content will be posted, a social media account where the custom content will be posted, a time by which the custom content will be posted, a content template for the custom content, and an identification of data sources for the custom content.

In some aspects, the first task is received from a user by a server in communication with the engine, and, responsive to the first task being received by the server, the server pushes the first task to the schedule database.

In some aspects, the template is generated by artificial intelligence (AI) and the template comprises one or more of an AI generated image and an AI generated text.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIGS. 1A and 1B illustrate a process flow for a cloud-based automated content creation system according to aspects of the disclosure.

FIG. 2 is a schematic diagram illustrating the architecture and communication flow for a cloud-based automated content creation system according to aspects of the disclosure.

FIGS. 3A and 3B illustrate a layering methodology associated with a template according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The cloud-based automatic content creation system presented herein takes advantage of the benefits afforded by digital marketing, while simultaneously simplifying both the creation of the digital marketing content and the publishing of the digital marketing content. While the systems discussed herein are described relative to a cloud-based implementation, it will be appreciated that some or all of the systems described may be implemented via physical servers or via a combination of cloud-based and physical server implementation. In some aspects, the same digital marketing content is automatically formatted for publication to multiple destinations, despite the different destinations having different requirements and procedures for publication. Furthermore, the system disclosed herein not only creates the digital marketing content, but also customizes and formats the digital marketing content to help generate and/or further the brand recognition of the user. A user may be a client who has contracted with an operator of automatic content creation system. For example, user-profile data is used to customize the generated digital marketing content with the “look and feel” of the user's brand so that there is increased recognition of the source of the content by potential customers. The system's ability to coordinate, process, and output customized digital marketing content not only greatly simplifies the process of creating and publishing digital marketing content from start to finish, but goes further to improve the user's brand recognition and strength through the creation of a customized look and feel for the custom digital marketing content that identifies the user as the source of the content. The ability to grow the brand of the user is a benefit that is not provided by conventional digital marketing.

### Terminology

In the following description, certain terminology is used to describe features of the invention. In certain situations, the term “logic” is representative of hardware, firmware, and/or software that is configured to perform one or more functions. As hardware, the logic may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the logic may be software in the form of one or more software modules. The software module(s) may include an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

The term “computerized” generally represents that any corresponding operations are conducted by hardware in combination with software and/or firmware.

The term “controller” may refer to a software instance deployed within a cloud computing environment (e.g., resources of a public cloud network) that manages operability of certain aspects of one or more cloud computing environments spanning across different public cloud networks (multi-cloud network). For instance, a controller may be configured to collect information pertaining to each VPC and/or each gateway and configures one or more routing tables associated with one or more VPCs and/or gateways spanning a multi-cloud network to establish communication links (e.g., logical connections) between different sources and destinations. These sources and/or destinations may include, but are not restricted or limited to on-premises computing devices, gateways or other types of cloud resources.

The term “message” generally refers to information in a prescribed format and transmitted in accordance with a suitable delivery protocol. Hence, each message may be in the form of one or more packets, frames, or any other series of bits having the prescribed format.

The term “network device” may be construed as any electronic computing system with the capability of processing data and connecting to a network. Such a network may be a public network such as the internet or a private network such as a wireless data telecommunication network, wide area network, a type of local area network (LAN), or a combination of networks. Examples of a network device may include, but are not limited or restricted to, an endpoint device (e.g., a laptop, a mobile phone, a tablet, a computer, etc.), a standalone appliance, a server, a router or other intermediary communication device, a firewall, etc.

The term “link” may be generally construed as a physical or logical communication path between two or more constructs. For instance, as a physical communication path, wired and/or wireless interconnects in the form of electrical wiring, optical fiber, cable, bus trace, or a wireless channel using infrared, radio frequency (RF), may be used. A logical communication path includes any communication scheme that enables information to be exchanged between multiple constructs.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

Reference will now be made to more specific embodiments of the present disclosure and data that provides support for such embodiments. However, it should be noted that the disclosure below is for illustrative purposes only and is not intended to limit the scope of the claimed subject matter in any way.

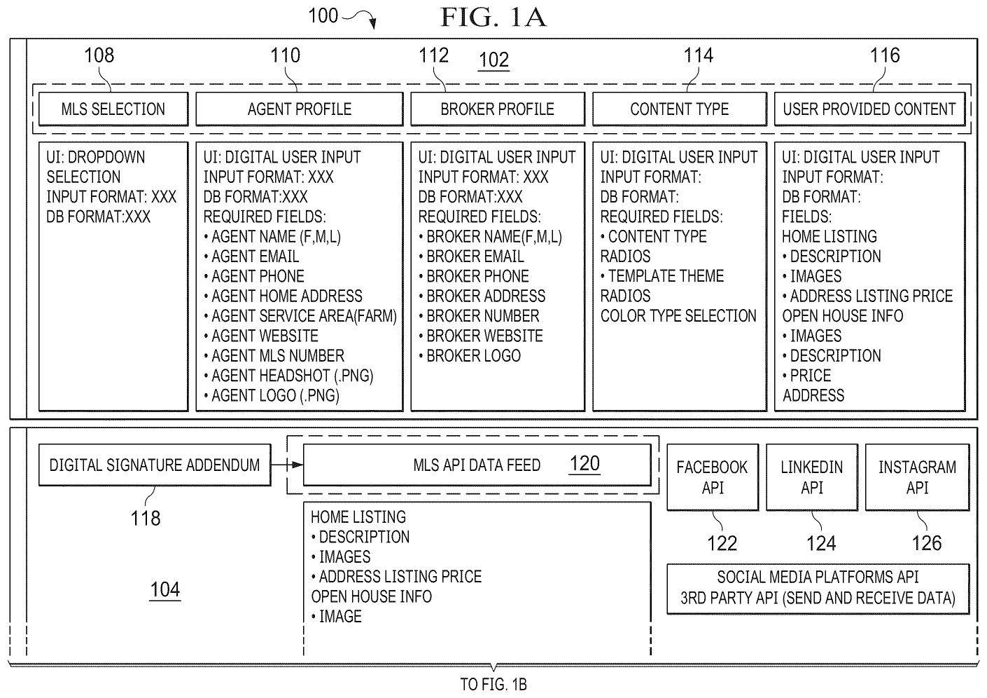

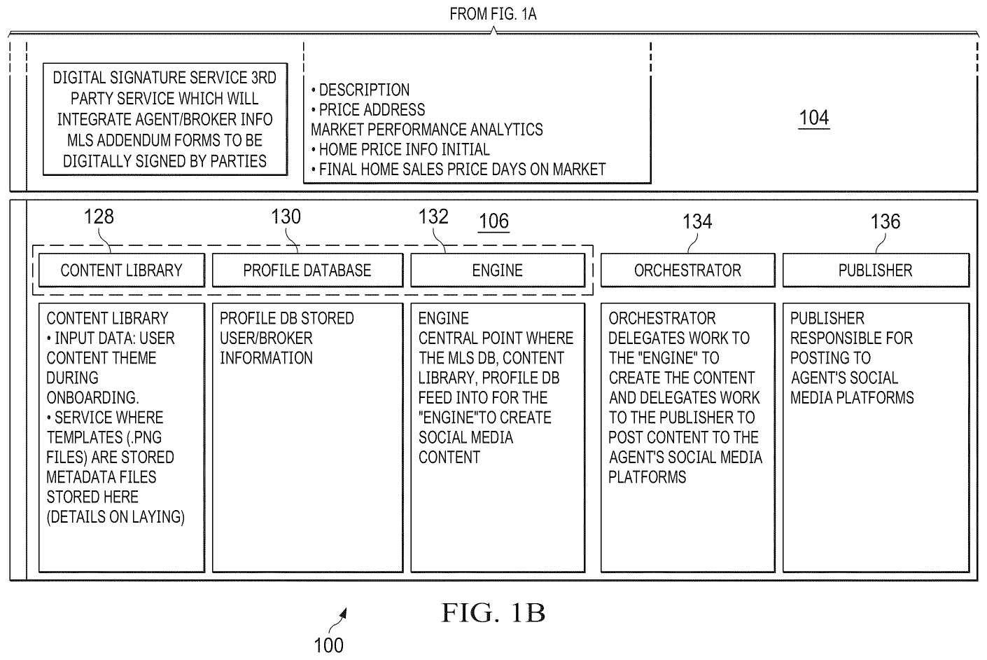

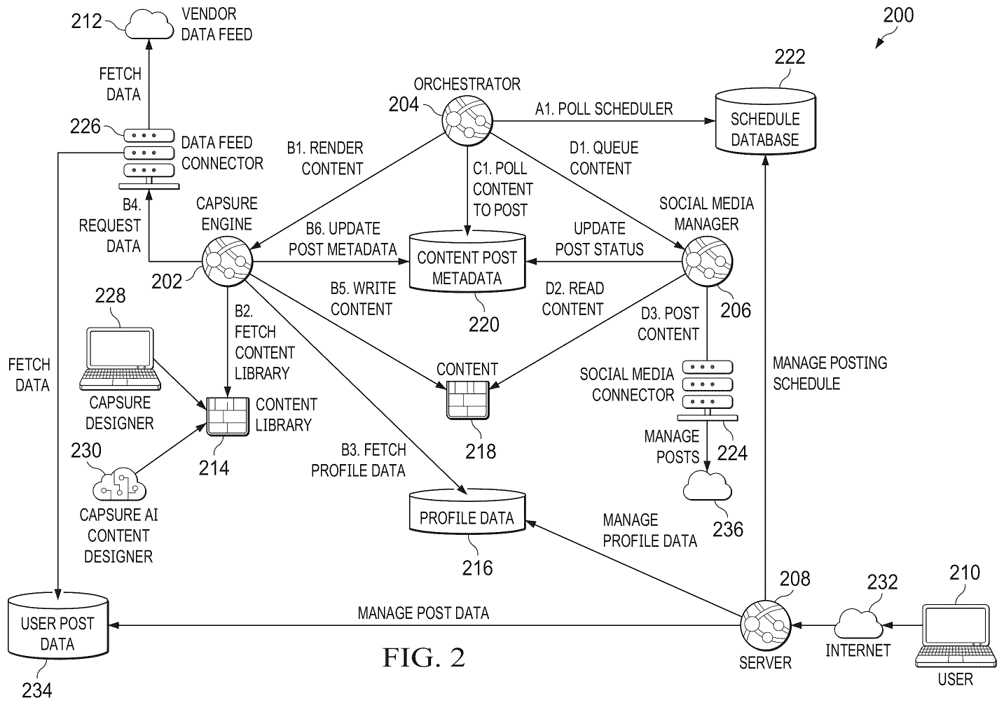

FIGS. 1A and 1B illustrate a process flow 100 for a cloud-based automated content creation system according to aspects of the disclosure. By way of example, flow 100 will be described using the creation of marketing content for residential real estate as a use case. Those having skill in the art will recognize that flow 100 has application beyond residential real estate use cases and has applicability to any business that uses digital marketing, including small business owners, insurance agencies, restaurants, automobile brands and dealerships, large business enterprises, financial Institutions, retail, media/publishing, and the like. Flow 100 is broken into three lanes or layers 102, 104, and 106. The system includes an engine (see lane 106) through which data received from various sources (e.g., the user and/or other third-party sources) is aggregated, processed, and merged into digital marketing content for publication to various external platforms (e.g., websites and social media platforms). The engine is directed by instructions sent from an orchestrator/controller (e.g., see orchestrator 204 in FIG. 2). The engine and orchestrator are applications that reside within a server (physical or cloud-based) and will be discussed in more detail relative to FIG. 2. The engine and orchestrator have associated with them a central processing unit, memory, disc and networking input/output, etc. Each of lanes 102, 104, 106, and 108 are discussed in more detail below.

Lane 102 describes the origin of data that is used by the engine to automatically generate the custom content. The primary data sources are the user (e.g., real estate agent) and a databases associated with the Multiple Listings Service (“MLS”), but other data sources could be included (e.g., social media accounts, customer web pages, customer database, etc.). Data collected from the agent may include: an MLS selection 108, an agent profile 110, a broker profile 112, content type 114, and user provided content 116. MLS selection 108 may include, for example, an identification of the MLS database(s) that the agent is using so that the engine knows which APIs to pull data from. Data pulled from the MLS API includes various details regarding the listing (e.g., photos, square footage, bedrooms, bathrooms, amenities, etc.). Agent profile 110 may include, for example, the agent's name, contact information, address, service area, website, MLS number, headshot, and logo. The system uses the agent profile data and the MLS selection data to automatically generate a digital signature addendum that grants the engine access to the MLS databases on the agent's behalf. The digital signature addendum is a form that is signed by the agent that grants third parties (i.e., the systems illustrated in FIGS. 1A-1B and 2) to access the agent's listings in the MLS database(s). Broker profile 112 may include, for example, the broker's name, contact information, address, broker number, web site, and logo. Content type 114 may be provided by the user (either directly inputted by the user, or collected via a data feed associated with the user) and may include user input regarding the look and feel of the content to be generated. For example, input regarding the look and feel may include color selections, template format, static text, images in JPG or PNG format, RGB color values, font names and styles, and the like. The system uses the collected data to generate custom digital marketing content that is automatically posted to the agent's chosen websites and/or social media platforms.

Lane 104 describes various API feeds from which additional data from the agent and the social media platforms is communicated to the engine. The API feeds include the Multiple Listing Services Feed API 120 and social media platform APIs 122, 124, 126. MLS API 120 provides data regarding the agent's listings. This data is merged with the agent's profile data and custom designed templates to create the custom digital marketing content. The system communicates with the external platform APIs 122, 124, 126 for various purposes. The primary purpose is to publish the custom digital marketing content. The system also communicates with the external APIs to gather analytics regarding the custom digital marketing content (e.g., clicks, views, interactions, etc.). Three external platform APIs are shown in FIGS. 1A-1B, but fewer or more APIs may be used as needed to reach whichever external platforms the user desires.

The system can also generate reports for users using these analytics. Additional reports may include automated newsletters that comprise an RSS feed that simplifies content creation and sharing processes. This allows users to maintain active social media profiles effortlessly, keeping their audience engaged and informed. The automated newsletters utilize the RSS feed to automatically aggregate articles sourced from the web based on user-specified keywords. Users can then review and select articles for sharing on their social media feeds directly. The system compiles and formats selected articles into personalized newsletters that reflect each user's branding and preferred types of content to share with their audience to drive engagement and conversation. This functionality also provides users an opportunity to allow businesses to advertise within the newsletter. This adds value for both the users who can monetize their newsletters and the advertisers who can access a niche, engaged audience.

Lane 106 describes an engine 132 and orchestrator 134. As noted above, engine 132 and orchestrator 134 are applications that run on a server in a cloud environment. Engine 132 has access to various data stores: an MLS database (see e.g., vendor data feed 212 in FIG. 2), a content library 128, and a profile database 130. The MLS database, agent profile, and broker profile data are discussed above with respect to lane 102. Content library 128 is a repository that stores various assets (e.g., graphics, frames, templates, metadata on layering, etc.) that engine 132 uses to generate custom content. Profile database 130 stores user-provided information that will be used in populating content template variables. In the context of a real estate agent, the agent's profile may include their contact information and listing preferences (which social media platforms that are used, content type, color preferences, etc.). Engine 132 pulls and coordinates information from these data stores to generate custom content for the agent. Engine 132 also communicates with a scheduler to push the custom content to the social media platforms at the desired time. Publisher 136 communicates with external platform APIs 122, 124, 126 to publish content generated by flow 100 to external platforms (e.g., social media sites, industry sites, etc.).

In some aspects, posting tokens are used for authentication. The posting token is an encrypted string used in authenticating/authorizing a programmatic request from one resource to another (e.g., publishing content from the engine to a social media outlet). In some aspects, OAuth flow may be used to issue tokens. This eliminates the need to require users to disclose credentials with a third-party, but allows the system to make requests on behalf of the user.

In some aspects, flow 100 may also provide customer relationship management (CRM) functionality that allows the user to manage contacts, messages, and daily tasks related to their social media marketing and customer interactions.

FIG. 2 is a schematic diagram illustrating the architecture and communication flow for a cloud-based automated content creation system 200 according to aspects of the disclosure. System 200 is representative of the system discussed above with respect to FIGS. 1A-1B. System 200 includes an engine 202, an orchestrator 204, a social media manager 206, a server 208, and a user 210. Social media manager 206 is an application that communicates with orchestrator 204, content post metadata database 220, content posts 218, and social media connector 224 to publish content to external platforms (e.g., social media platforms, industry websites, and the like). Engine 202 is responsible for merging data from the various data sources (e.g., a vendor data feed 212, a content library 214, a profile database 216, content posts 218, content post metadata database 220, and user post data 234), and for generating custom content that will ultimately be produced as a final rendering for publication to a social media platform.

FIG. 2 illustrates server 208 as a separate entity to other components of FIG. 2, however it should be known that, in some aspects, server 208 comprises one or more of engine 202, orchestrator 204, social media manager 206, content library 214, profile database 216, content posts 218, content post metadata database 220, and schedule database 222. Server 208 and its various applications and datastores may reside on a physical server or may reside in a cloud environment.

Engine 202 receives instructions from orchestrator 204 in the form a message that identifies the data to be used and the template into which the data will be inserted. Orchestrator 204 is a controller that delegates work and/or communicates with other modules in system 200 (e.g., engine 202, schedule database 222, social media manager 206, and content post metadata database 220). Orchestrator 204 prevents dependencies between modules, improving performance of the system by allowing for single responsibility among the various modules. While orchestrator 204 is aware of all modules involved, it is completely unaware of the work being performed and only sends instructions to the other modules to perform the delegated tasks. Orchestrator 204 is primarily responsible for polling schedule database 222 for tasks to be performed (e.g., polling of schedule database fetches tasks to notify engine 202 to begin rendering a content post, polling of content post metadata database fetches tasks to notify social media manager to begin publishing content to social media accounts), supplying engine 202 with tasks (e.g., creating custom content), polling content post metadata database 220 for final renderings that are ready to publish, and notifying social media manager 206 that content is ready to publish to one or more social media platforms.

An exemplary flow for automatic custom content creation begins with orchestrator 204 polling schedule database 222. Schedule database 222 stores a queue of jobs. A job record holds the details of a single content post, including: the user for which the content will be posted, the social media account where the content will be posted, the time by which the content will be posted, the content template to use in rendering the content, and the data sources (e.g., user profiles and data feeds to merge with the content template). A task for content generation results from user 210 submitting data to server 208. User 210, which may be a personal computer, mobile device, tablet, etc., may submit data to server 208 via an internet connection 232. Server 208 may be, for example, a cloud-based server. Once data is received from user 210, server 208 pushes the data to schedule database 222, profile database 216, and content post metadata database 220.

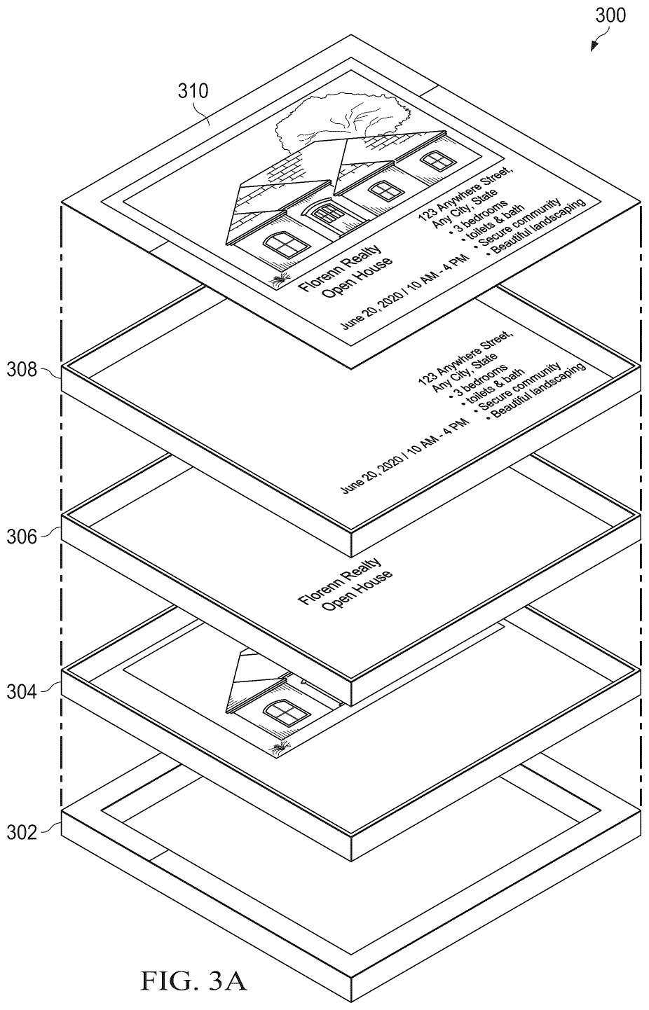

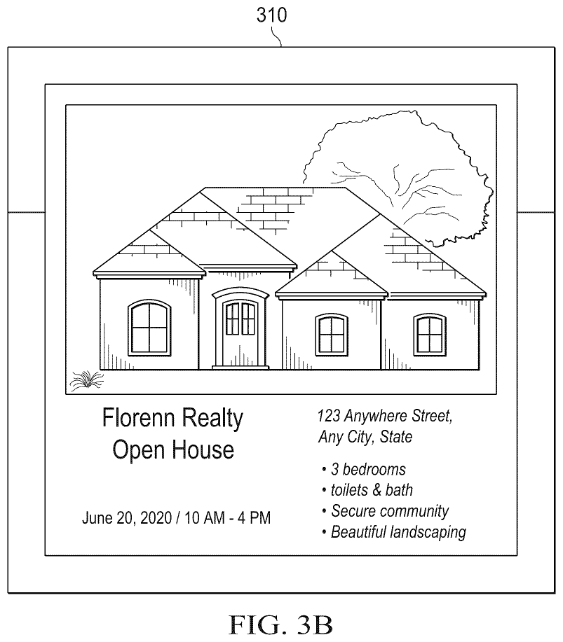

Orchestrator 204 next instructs engine 202 to render content. The rendering of content by engine 202 includes pulling and/or generating a template from content library 214. Templates define an ordered set of layers. The layering process defines a set of simpler individual components to render, after which they can be stacked atop one another to produce a final more complex composition. This approach makes it possible to use the same layer components but produce different results in a different appearance in color, font, and images. Any other approach might require image masking techniques to define variable regions, which highly complicates the logic to achieve the same result. In other words, the layering process used herein improves the efficiency of operation for the system. A layer is itself transparent, and comprises an optional background image and/or a rectangular region where text will be positioned on the layer. Text is configured with a font and size. Each layer is merged with the source data and stacked atop one another in order. Finally, the layers are flattened to produce the final rendering. FIGS. 3A and 3B illustrate the layers of a template and a final output. This layering technique creates a “look and feel” for the customer that is unique to the customer. This unique look can be stored and replicated across their content to define a brand for the customer. In other aspects, a default template may be used absent a user-identified template. Templates are populated in content library 214 from a content library user 228. Templates are initially generated by, for example, a graphics designer and supplied to content library user 228. Users may choose from existing templates or may work with the graphics designer to have custom templates generated.

In some aspects, system 200 includes an artificial intelligence content designer 230 that is responsible for creating unique templates to be used by the engine to create content. This could include creating new content layouts, images, and text that will be used by the engine to generate content. The functionality includes, but is not limited to, smart digital content processing, digital image creation, text content generation, image quality enhancements.

Next, engine 202 pulls profile data from profile database 216. The profile data, discussed above relative to FIGS. 1A-1B, is data supplied by user 210. Engine 202 also pulls information from MLS data feed 212 via an MLS data feed connector 226. MLS data feed connector 226 provides an interface to pull content data from either the MLS database, user post data 234, or both depending on the inputs from the engine and what template is driving the behavior. Content data comprises data describing the custom content being generated. Using real estate as an example, content data can include images and/or data describing a piece of real property. For example, if engine 202 is putting together content for an event (e.g., an open house), engine 202 will attempt to get the required data from connector 226 (e.g., listing price, address, date/time) and connector 226 will decide whether that data will need to come from the MLS, the user provided database, or a combination of information from both sources. In the context of automobile sales, the content data can include images and/or data describing an automobile (make, model, price, mileage, etc.). User post data 234 may include, for example, images, home address, open house date, pricing, listing status, etc.

Engine 202 then merges the profile data with the template to generate the custom content. Engine 202 writes the generated custom content to content posts 218 for storage and updates content post metadata database 220.

After the content has been created, orchestrator 204 becomes aware of the completed content via polling of content post metadata database 220 and instructs social media manager 206 to publish the custom content. In some instances, content is published as soon as it is available. In other instances, content is published at a scheduled time in the future. Once it is time for the content to be published, social media manager 206 reads the content from content posts database 216 and sends the content to social media connector 224. Social media connector 224 then pushes the content out to API(s) of the social media platform(s) that were designated by user 210.

FIGS. 3A and 3B illustrate a layering methodology 300 associated with a template 310 according to aspects of the disclosure. FIG. 3A illustrates a plurality of layers 302-308 prior to being merged to form a template 310. FIG. 3B illustrates template 310 with all layers merged and rendered. Layering methodology 300 defines a set of simple, individual components to render that are stacked atop one another to produce the final, more complex composition of template 310. This approach makes it possible to use the same layer components (e.g., variations and/or customizations of each layer 302-308) to produce unique results that differ in appearance (e.g., color, style, font, and images). These uniquely generated templates 310 allow a user to create a look and feel that is uniquely their brand. Layering methodology 300 elevates system 200 to more than just a way to collect, process, manage, and publish data; system 200 generates unique user identities in the market place to help differentiate those users to establish brand recognition. Other approaches can require image masking techniques to define variable regions, which highly complicates the logic to achieve the same result. In other words, layering methodology 300 improves the efficiency of operation of the system.

Each layer 302-308 is itself transparent, and comprises an optional background image and/or a rectangular region where text can be positioned on the layer. Text is configured with a font, color, and size. In the example shown in FIG. 3A, layer 302 includes a frame that surrounds text/images of the other layers. The frame of layer 302 may be comprised of various styles. For example, layer 302 is shown having a first portion in a first color and a second portion in a second color. In other aspects, layer 302 may have only one portion or more than two portions. In various aspects, layer 302 may comprise one or more graphic design elements that make up the frame. For example, holiday or other themed graphics may make up the design of the frame (e.g., cornucopia for Thanksgiving holidays, wreaths for Christmas holidays, and the like).

Layer 304 is shown as an image or graphic layer that includes an image of a home being listed for sale. The image of layer 304 may be an image that is pulled from vendor data feed 212 (e.g., MLS database) or an image from user post data 234.

Layer 306 is a message layer that displays text. The unique message text may be provided by the user or selected from defaults. By way of example, FIGS. 3A-3B illustrate a message of “Florenn Realty Open House.”

Layer 308 is a data layer that displays one or more attributes of the content being marketed. For example, for a home listing, layer 308 displays data collected from vendor data feed 212 (e.g., MLS database) or an image from user post data 234. By way of example, the data displayed regarding a home listing may include: an address, number of bedrooms, number of bathrooms, amenities, size, list price, and the like.

Each layer 302-308 is merged and flattened to produce the final rendering of template 310. Once created, template 310 and the collection of aesthetic selections (e.g., colors, fonts, graphics, etc.) may be saved as a default template for that user. This default template forms the basis of the user's look and feel for future templates. It will be appreciated that the number of layers may be increased or decreased to create different aesthetics and/or to present more/less data as needed.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded. #

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein. #

What is claimed is:

1. A cloud-based computer implemented method for automatic generation and publication of custom content, comprising executing on a processor the steps of:
receiving, by an orchestrator, a first task to be performed from a schedule database;
instructing, by the orchestrator, an engine to perform the first task;
receiving, by the engine, data comprising profile data, a template from a content library, and content data; and
rendering, by the engine, the custom content by creating a plurality of layers, each layer of the plurality of layers comprising an aspect of one or more of the data, and combing the plurality of layers to create the custom content.

2. The method of claim 1, further comprising:
writing, by the engine, the custom content to a content posts storage; and
updating a content post metadata database.

3. The method of claim 2, further comprising, instructing, by the orchestrator, a social media manager to publish the custom content to an external platform.

4. The method of claim 1, further comprising:
polling by the orchestrator, a content post metadata database; and
responsive to the custom content being found in the content post metadata databases, instructing, by the orchestrator, a social media manager to publish the custom content to an external platform.

5. The method of claim 4, wherein the custom content is published as soon as it is available.

6. The method of claim 4, wherein the custom content is published at a scheduled time in the future.

7. The method of claim 4, wherein the custom content is published to a social media platform designated in the profile data.

8. The method of claim 1, wherein a first layer of the plurality of layers comprises a frame, the frame comprising a design element stored in the profile data.

9. The method of claim 8, wherein a second layer of the plurality of layers comprises data from the content data.

10. The method of claim 1, wherein the first task is a record comprising parameters of the custom content including one or more of a user for which the custom content will be posted, a social media account where the custom content will be posted, a time by which the custom content will be posted, a content template for the custom content, and an identification of data sources for the custom content.

11. The method of claim 1, wherein the first task is received from a user by a server in communication with the engine.

12. The method of claim 11, wherein responsive to the first task being received by the server, the server pushes the first task to the schedule database.

13. The method of claim 1, wherein the template is generated by artificial intelligence (AI).

14. The method of claim 13, wherein the template comprises one or more of an AI generated image and an AI generated text.

15. A non-transitory storage medium having stored thereon logic that, upon execution, causes operations including:
receiving, by an orchestrator, a first task to be performed from a schedule database;
instructing, by the orchestrator, an engine to perform the first task;
receiving, by the engine, data comprising profile data, a template from a content library, and content data; and
rendering, by the engine, the custom content by creating a plurality of layers, each layer of the plurality of layers comprising an aspect of one or more of the data, and combing the plurality of layers to create the custom content.

16. The non-transitory storage medium of claim 15, wherein the operations further include:
writing, by the engine, the custom content to a content posts storage; and
updating a content post metadata database.

17. The non-transitory storage medium of claim 15, wherein the operations further include:
polling by the orchestrator, a content post metadata database; and
responsive to the custom content being found in the content post metadata databases, instructing, by the orchestrator, a social media manager to publish the custom content to an external platform.

18. The non-transitory storage medium of claim 15, wherein the first task is a record comprising parameters of the custom content including one or more of a user for which the custom content will be posted, a social media account where the custom content will be posted, a time by which the custom content will be posted, a content template for the custom content, and an identification of data sources for the custom content.

19. The non-transitory storage medium of claim 15, wherein the first task is received from a user by a server in communication with the engine, and, responsive to the first task being received by the server, the server pushes the first task to the schedule database.

20. The non-transitory storage medium of claim 15, wherein the template is generated by artificial intelligence (AI) and the template comprises one or more of an AI generated image and an AI generated text.
